(19) United States
(12) Patent Application Publication
(10) Pub. No.: US 2017/0211231 A1
(43) Pub. Date: Jul. 27, 2017

(54) Methods for Treating Lignocellulosic Material

(71) Applicant: LEAF SCIENCES PTY LTD, Queensland (AU)

(72) Inventors: Alex Baker, Queensland (AU); Leslie Alan Edye, Queensland (AU)

(21) Appl. No.: 15/324,955

(22) PCT Filed: Jul. 10, 2015
(86) PCT No.: PCT/AU2015/050389

§ 371 Date: Jan. 9, 2017

(30) Foreign Application Priority Data
Jul. 10, 2014 (AU) 2014902666
Oct. 29, 2014 (AU) 2014904334

(51) Int. Cl. D21C 3/02; D21C 1/06; C08B 11/12; D21C 3/00; D21F 7/00; D21C 9/02; D21C 1/04; D21C 3/04

(52) U.S. Cl. CPC D21C 3/02; D21C 1/04; D21C 1/06; D21C 3/04; D21C 3/003; D21F 7/00; D21C 9/02; C08B 11/12

(57) ABSTRACT

A method for producing a modified cellulosic material is provided including treating a lignocellulosic material with an acid and/or an alkali and then a polyol. Also provided are methods of producing a paper-based product and a cellulose derivative from said modified cellulosic material. A modified cellulosic material, a paper-based product and a cellulose derivative produced by such methods are also provided. Also provided is an apparatus for producing a modified cellulosic material, such as by the aforementioned method.

### TECHNICAL FIELD

THIS INVENTION relates to methods for producing modified cellulosic material that can be subsequently used to produce useful products, such as paper-based products and/or cellulose derivatives.

### BACKGROUND

Lignocellulosic material can be used to produce a cellulosic material, such as a cellulose pulp, that may be amenable to various downstream uses such as paper, cardboard and textile production. Further, the cellulosic material may be useful for producing derivatives of cellulose, such as carboxymethyl cellulose (CMC) and microcrystalline cellulose. The cellulose source and the cellulose processing conditions, however, generally dictate the cellulosic material characteristics, and therefore, its applicability for certain end uses.

For the efficient production of cellulosic material from lignocellulosic material, a proportion of the lignin and/or hemicellulose components of the lignocellulosic material typically need to be removed. This is generally achieved by degrading the lignin and/or hemicellulose into small, water-soluble molecules that can be subsequently separated from the cellulose fibres without depolymerizing the cellulose fibres. When cellulose is degraded, however, such as by depolymerization or by significantly reducing the fibre length and/or strength, it may be subsequently unsuitable for many downstream applications. Accordingly, a need remains for methods of treating lignocellulosic material so as to produce a cellulosic pulp or fibre that possesses characteristics, such as improved carboxylic acid and aldehyde functionalities, for the downstream production of paper-based products and/or cellulose derivatives, but in doing so avoid extensively degrading the cellulose fibres therein.

Traditionally, cellulose sources that were useful in the production of paper-based products were not also suitable for the production of downstream cellulose derivatives, such as cellulose ethers and cellulose esters. The production of low viscosity cellulose derivatives from high viscosity cellulose raw materials requires additional manufacturing steps that would add significant cost while imparting unwanted by-products and reducing the overall quality of the cellulose derivative. Cotton linter, kraft and high alpha cellulose content sulfite pulps are typically used in the manufacture of cellulose derivatives, such as cellulose ethers and esters. However, production of cotton linter, kraft and sulfite fibre with a high degree of polymerization (DP) and/or viscosity is expensive due to the cost of the starting material, the high energy, chemical, and environmental costs of pulping and bleaching and/or the extensive purifying processes required.

In addition to the high cost, there is a dwindling supply of sulfite pulps available to the market. Therefore, these pulps are very expensive, and have limited applicability in pulp and paper applications, for example, where higher purity or higher viscosity pulps may be required. For cellulose derivative manufacturers these pulps constitute a significant portion of their overall manufacturing cost. Thus, there exists a need for a cellulosic material that is relatively inexpensive to produce, yet is highly versatile, enabling its use in a variety of downstream applications, such as the production of paper-based products and/or cellulose derivatives.

### SUMMARY

The present invention is predicated in part on the surprising discovery that sequentially treating lignocellulosic material with an acid and/or an alkali, and then a polyol, and in particular glycerol, results in a modified cellulosic material that has retained fibre pulp properties that may make it useful as a fibre pulp for the production of paper-based products. Additionally or alternatively, this cellulose material may be amendable to the production of cellulose derivatives, such as CMC.

In a first aspect, the invention provides a method for producing a modified cellulosic material including the steps:

(i) treating a lignocellulosic material with an acid and/or an alkali;

(ii) treating the lignocellulosic material of step (i) with an agent that comprises, consists or consists essentially of a polyol;

thereby producing a modified cellulosic material.

In certain embodiments, at step (i) the lignocellulosic material is treated with: (a) acid alone; (b) alkali alone; (c) sequentially with acid and then alkali; or (d) sequentially with alkali and then acid.

Suitably, the acid is selected from the group consisting of sulphuric acid, hydrochloric acid, phosphoric acid, hydrofluoric acid, hydrobromic acid, nitric acid, acid metal salts and any combination thereof.

Preferably, the acid is sulphuric acid.

Suitably, the alkali is selected from the group consisting of sodium hydroxide, potassium hydroxide, ammonium hydroxide, alkali metal salts and any combination thereof.

Preferably, the alkali is sodium hydroxide.

In a preferred embodiment, step (i) includes steam impregnating the acid and/or alkali into and/or onto the lignocellulosic material.

In a preferred embodiment, the acid is present in an amount of about 0.1% to about 5% by weight of the lignocellulosic material.

In a preferred embodiment, the alkali is present in an amount of about 0.1% to about 15% by weight of the lignocellulosic material.

Suitably, the polyol is selected from the group consisting of glycerol, ethylene glycol and any combination thereof.

Preferably, the polyol is glycerol.

In one embodiment, the glycerol is or comprises crude glycerol.

Suitably, step (i) is carried out at a temperature from about 20° C. to about 99° C. or preferably from about 25° C. to about 75° C.

Suitably, step (ii) is carried out at a temperature from about 120° C. to about 200° C.

Preferably, step (ii) is carried out at a temperature of about 160° C. Suitably, step (i) is carried out for a period of time from about 5 minutes to about 30 minutes.

Suitably, step (ii) is carried out for a period of time from about 15 minutes to about 60 minutes.

Preferably, step (ii) is carried out for a period of time of about 30 minutes.

In a particular embodiment, step (i) further comprises washing the lignocellulosic material after treatment with the acid and/or alkali so as to, at least partly, remove the acid and/or alkali prior to the commencement of step (ii).

Suitably, the polyol is present in an amount of about 10% to about 200% by weight of the lignocellulosic material.

In a second aspect, the invention provides a modified cellulosic material produced by the method of the first aspect.

In one embodiment, the modified cellulosic material has a cellulose yield of about 50% to about 60% by dry weight of solid material resulting from the treatment.

In one embodiment, the modified cellulosic material has a kappa number of about 50 to about 150.

In one embodiment, the modified cellulosic material has a solution viscosity of about 5 to about 35 mPa.

In a third aspect, the invention provides a method of producing a paper-based product including the step of treating a modified cellulosic material produced according to the method of the first aspect to thereby produce a paper-based product.

In certain embodiments, the step of treating the modified cellulosic material is performed, at least part thereof, by contacting the modified cellulosic material with one or more agents selected from the group consisting of a filler agent, a sizing agent, a bleaching agent, a bleaching additive, a sequestering agent, a wet strength additive, a dry strength additive, an optical brightening agent, a colouring agent, a retention agent, a coating binder and any combination thereof.

In a fourth aspect, the invention provides a method of producing a cellulose derivative including the step of treating a modified cellulosic material produced according to the method of the first aspect to thereby produce the cellulose derivative.

In particular embodiments, the cellulose derivative is selected from the group consisting of a cellulose ether, a cellulose ester, viscose and microcrystalline cellulose.

In one embodiment, the cellulose derivative is or comprises a cellulose ether selected from the group consisting of ethylcellulose, methylcellulose, hydroxypropyl cellulose, carboxymethyl cellulose, hydroxypropyl methylcellulose hydroxyethyl methylcellulose and any combination thereof.

In one embodiment, wherein the cellulose derivative is or comprises a cellulose ether, the step of treating the modified cellulosic material includes contacting the modified cellulosic material with one or more agents selected from the group consisting of chloromethane, chloroethane, ethylene oxide, propylene oxide, chloroacetic acid and any combination thereof to thereby produce the cellulose ether.

In one embodiment, the cellulose derivative is or comprises a cellulose ester selected from the group consisting of cellulose acetate, cellulose triacetate, cellulose propionate, cellulose acetate propionate, cellulose acetate butyrate, cellulose sulfate and cellulose nitrate.

In one embodiment, wherein the cellulose derivative is or comprises a cellulose ester, the step of treating the modified cellulosic material includes contacting the modified cellulosic material with one or more agents selected from the group consisting of acetic acid, acetic anhydride, propanoic acid, butyric acid, nitric acid, sulphuric acid and any combination thereof to thereby produce the cellulose ester.

In one embodiment, wherein the cellulose derivative is or comprises microcrystalline cellulose, the step of treating the modified cellulosic material includes contacting the modified cellulosic material with an acid and/or alkali to thereby produce microcrystalline cellulose.

In one embodiment, wherein the cellulose derivative is or comprises viscose, the step of treating the modified cellulosic material includes contacting the modified cellulosic material with one or more agents selected from the group consisting of sodium hydroxide and carbon disulfide to thereby produce viscose.

In a fifth aspect, the invention provides an apparatus for producing a modified cellulosic material comprising: a treatment chamber for treating a lignocellulosic material with an acid and/or an alkali in communication with a digestion chamber for treating the lignocellulosic material with an agent that comprises, consists or consists essentially of a polyol.

Suitably, the treatment chamber is capable of impregnating the lignocellulosic material with the acid and/or the alkali.

In certain embodiments, the apparatus further comprises a pre-treatment chamber which is capable of steaming the lignocellulosic material, such as for wetting and/or pre-heating the lignocellulosic material.

In some embodiments, the apparatus further comprises a separator for separating at least part thereof the modified cellulosic material from a liquid fraction.

Suitably, the apparatus is suitable for use in the method of the first aspect.

Throughout this specification, unless otherwise indicated, “comprise”, “comprises” and “comprising” are used inclusively rather than exclusively, so that a stated integer or group of integers may include one or more other non-stated integers or groups of integers. Conversely, the terms “consist”, “consists” and “consisting” are used exclusively, such that a stated integer or group of integers are required or mandatory, and no other integers may be present. The phrase “consisting essentially of” indicates that a stated integer or group of integers are required or mandatory, but that other elements that do not interfere with or contribute to the activity or action of the stated integer or group of integers are optional.

It will also be appreciated that the indefinite articles “a” and “an” are not to be read as singular indefinite articles or as otherwise excluding more than one or more than a single subject to which the indefinite article refers. For example, “a” protein includes one protein, one or more proteins or a plurality of proteins.

### BRIEF DESCRIPTION OF THE DRAWINGS

By way of example only, embodiments of the invention are described more fully hereinafter with reference to the accompanying drawings, in which:—

FIG. 1 is a schematic of an apparatus according to a preferred embodiment of the invention.

FIG. 2 demonstrates freeness (drainage) versus 418 refining energy for the lignocellulosic materials of Example 3.

FIG. 3 demonstrates length weighted average versus 418 refining energy for the lignocellulosic materials of Example 3.

FIG. 4 demonstrates length weighted average versus freeness for the lignocellulosic materials of Example 3.

### DETAILED DESCRIPTION

The present invention arises, in part, from the identification of novel methods of producing modified cellulosic material, which may be used in downstream applications to produce paper-based products, such as cardboard or the like, and/or cellulose derivatives. In particular these novel methods provide for an improved treatment of lignocellulosic material to produce a cellulose pulp or fibre that is relatively inexpensive to process, yet is highly versatile, enabling its use in a variety of downstream applications. Additionally, the methods described herein typically have lower input costs and are more efficient than those previously described in the art.

Accordingly, the process disclosed herein provides a method to produce modified cellulosic material quickly, which is important for the economics of converting biomass to useful downstream products, which can then be used as a base for producing green renewable bio-based products. The process disclosed herein can save significant digestion time. Key features of the process include: a single stage continuous process; short resonance time; low temperature and low pressure; low cost recyclable reagents; scalable and efficacious treatment demonstrated; and suitable for both non-woody and woody feedstocks.

In one aspect, the invention provides a method for producing a modified cellulosic material including the steps:

(i) treating a lignocellulosic material with an acid and/or an alkali;

(ii) treating the lignocellulosic material of step (i) with an agent that comprises, consists or consists essentially of a polyol;

thereby producing a modified cellulosic material.

As used herein “modified cellulosic material” refers to that material resulting from the treatment of the lignocellulosic material which has been treated (e.g. hydrolysed, cooked, etc) in accordance with the present disclosure.

The terms “lignocellulosic” or “lignocellulose”, as used herein, refer to material comprising lignin and/or cellulose. Lignocellulosic material can also comprise hemicellulose, xylan, proteins, lipids, carbohydrates, such as starches and/or sugars, or any combination thereof. Lignocellulosic material can be derived from living or previously living plant material (e.g., lignocellulosic biomass). “Biomass”, as used herein, refers to any lignocellulosic material and can be used as an energy source.

The source of the cellulosic material may dictate the cellulose fiber characteristics, and therefore, the fiber's applicability for certain end uses. In this regard, lignocellulosic material (e.g., lignocellulosic biomass) can be derived from a single material or a combination of materials and/or can be non-modified and/or modified. Lignocellulosic material can be transgenic (i.e., genetically modified). Lignocellulose is generally found, for example, in the fibers, pulp, stems, leaves, hulls, canes, husks, and/or cobs of plants or fibers, leaves, branches, bark, and/or wood of trees and/or bushes. Examples of lignocellulosic materials include, but are not limited to, agricultural biomass, e.g., farming and/or forestry material and/or residues, branches, bushes, canes, forests, grains, grasses, short rotation woody crops, herbaceous crops, and/or leaves; energy crops, e.g., corn, millet, and/or soybeans; energy crop residues; paper mill residues; sawmill residues; municipal paper waste; orchard prunings; chaparral; wood waste; wood chip, logging waste; forest thinning; short-rotation woody crops; bagasse, such as sugar cane bagasse and/or sorghum bagasse, duckweed; wheat straw; oat straw; rice straw; barley straw; rye straw; flax straw; soy hulls; rice hulls; rice straw; tobacco; corn gluten feed; oat hulls; corn kernel; fiber from kernels; corn stover; corn stalks; corn cobs; corn husks; canola; miscanthus; energy cane; prairie grass; gamagrass; foxtail; sugar beet pulp; citrus fruit pulp; seed hulls; lawn clippings; cotton, seaweed; trees; shrubs; wheat; wheat straw; products and/or by-products from wet or dry milling of grains; yard waste; plant and/or tree waste products; herbaceous material and/or crops; forests; fruits; flowers; needles; logs; roots; saplings; shrubs; switch grasses; vegetables; fruit peels; vines; wheat midlings; oat hulls; hard and soft woods; or any combination thereof.

For the present invention, the lignocellulosic material may have been processed by a processor selected from the group consisting of a paper pulping facility, a tree harvesting operation, a sugar cane factory, or any combination thereof.

Suitably, the lignocellulosic material used in the methods described herein is derived from softwood fibre, hardwood fibre, grass fibre and/or mixtures thereof.

In one embodiment, the lignocellulosic material is or comprises an annual grass.

In one embodiment, the lignocellulosic material comprises wood chip, material and/or residue from Eucalyptus globulus or Eucalyptus nitans.

It would be appreciated by the skilled artisan, that treatment of the lignocellulosic material may result in hydrolysis, including partial hydrolysis, thereof.

By “hydrolysis” is meant the cleavage or breakage of the chemical bonds that hold the lignocellulosic material together. For instance, hydrolysis can include, but is not limited to, the breaking or cleaving of glycosidic bonds that link saccharides (i.e., sugars) together, and is also known as saccharification. Lignocellulosic material, in some embodiments, can comprise cellulose and/or hemicellulose. Cellulose is a glucan, which is a polysaccharide. Polysaccharides are polymeric compounds that are made up of repeating units of saccharides (e.g., monosaccharides or disaccharaides) that are linked together by glycosidic bonds. The repeating units of saccharides can be the same (i.e., homogenous) to result in a homopolysaccharide or can be different (i.e., heterogeneous) to result in a heteropolysaccharide. Cellulose can undergo hydrolysis to form cellodextrins (i.e., shorter polysaccharide units compared to the polysaccharide units before the hydrolysis reaction) and/or glucose (i.e. a monosaccharide). Hemicellulose is a heteropolysaccharide and can include polysaccharides, including, but not limited to, xylan, glucuronoxylan, arabinoxylan, glucomannan and xyloglucan. Hemicellulose can undergo hydrolysis to form shorter polysaccharide units, and/or monosaccharides, including, but not limited to, pentose sugars, xylose, mannose, glucose, galactose, rhamnose, arabinose, or any combination thereof.

In one embodiment, the method of the present invention partially hydrolyses the lignocellulosic material. “Partial hydrolysis” or “partially hydrolyses” and any grammatical variants thereof, as used herein, refer to the hydrolysis reaction cleaving or breaking less than 100% of the chemical bonds that hold the lignocellulosic material together.

In other embodiments of the present invention, the hydrolysis reaction cleaves or breaks less than 100% of the glycosidic bonds of the cellulose and/or hemicellulose present in the lignocellulosic material. In some embodiments, the partial hydrolysis reaction can convert less than about 20%, 15%, 10%, or 5% of the cellulose into glucose. In further embodiments of this invention, the partial hydrolysis reaction can convert less than about 20%, 15%, 10%, or 5% of the hemicellulose into monosaccharides. Examples of monosaccharides include but are not limited to, xylose, glucose, mannose, galactose, rhamnose, and arabinose. Additionally, the partial hydrolysis reaction may result in the recovery of greater than about 80%, 85%, 90%, or 95% of the glucan present in the modified cellulosic material compared to the amount of glucan present in the lignocellulosic material before treatment with the method described herein.

In some embodiments of the present invention, the partial hydrolysis reaction can result in the recovery of less than about 40%, 35%, 30%, 25%, 20%, 15%, 10%, or 5% of the xylan in the modified cellulosic material compared to the amount of xylan present in the lignocellulosic material before treatment with the method of the current aspect.

As would be readily understood by the skilled artisan, the method described herein may break down and/or remove the lignin present in the lignocellulosic material. Lignin may be removed from the lignocellulosic material by hydrolysis of the chemical bonds that hold the lignocellulosic material together. Accordingly, in some embodiments of the present invention, the method results in the removal of about 80% or less (e.g., about 80%, 75%, 70%, 65%, 60%, 55%, 50%, 45%, 40%, 35%, 30%, 25%, 20%, etc.) or any range therein of the lignin in the modified cellulosic material compared to the amount of lignin present in the lignocellulosic material prior to the treatment with the method. In some embodiments, the method results in the recovery of about 20% or more (e.g., about 20%, 25%, 30%, 35%, 40%, 45%, 50%, 55%, 60%, 65%, 70%, 75%, 80%, etc.) or any range therein of the lignin in the modified cellulosic material compared to the amount of lignin present in the lignocellulosic material prior to treatment with the method of the present aspect.

Furthermore, the method described herein may affect the structure of the lignocellulosic material. For instance, the method may result in the dissociation of fibres in the lignocellulosic material, increase the porosity of the lignocellulosic material, increase the specific surface area of the lignocellulosic material, or any combination thereof. In some embodiments, the method reduces the crystallinity of the cellulose structure by, for example, changing a portion of the cellulose from a crystalline state to an amorphous state.

As used herein, “treating” or “treatment” may refer to, for example, contacting, soaking, steam impregnating, spraying, suspending, immersing, saturating, dipping, wetting, rinsing, washing, submerging, and/or any variation and/or combination thereof.

Suitably, for step (i) the lignocellulosic material is treated with the acid.

The skilled person would readily understand that the term “acid”, as used herein, refers to various water-soluble compounds with a pH of less than 7 that can be reacted with an alkali to form a salt. Examples of acids can be monoprotic or polyprotic and can comprise one, two, three, or more acid functional groups. Examples of acids include, but are not limited to, mineral acids, Lewis acids, acidic metal salts, organic acids, solid acids, inorganic acids, or any combination thereof. Specific acids include, but are not limited to hydrochloric acid, sulfuric acid, phosphoric acid, hydrofluoric acid, hydrobromic acid, hydroiodic acid, nitric acid, formic acid, acetic acid, methanesulfonic acid, toluenesulfonic acid, boron trifluoride diethyletherate, scandium (III) trifluoromethanesulfonate, titanium (IV) isopropoxide, tin (IV) chloride, zinc (II) bromide, iron (II) chloride, iron (III) chloride, zinc (II) chloride, copper (I) chloride, copper (I) bromide, copper (II) chloride, copper (II) bromide, aluminum chloride, chromium (II) chloride, chromium (III) chloride, vanadium (III) chloride, molybdenum (III) chloride, palladium (II) chloride, platinum (II) chloride, platinum (IV) chloride, ruthenium (III) chloride, rhodium (III) chloride, zeolites, activated zeolites, or any combination thereof.

Preferably, the acid is selected from the group consisting of sulphuric acid, hydrochloric acid, phosphoric acid, hydrofluoric acid, hydrobromic acid, nitric acid, acid metal salts and any combination thereof.

Even more preferably, the acid is sulphuric acid.

Suitably, for step (i) the lignocellulosic material is treated with the alkali.

As would be readily understood by the skilled artisan, “alkali”, as used herein, refers to various water-soluble compounds with a pH of greater than 7 that can be reacted with an acid to form a salt. By way of example, an alkali can include, but is not limited to, sodium hydroxide, potassium hydroxide, ammonium hydroxide, magnesium hydroxide and alkali metal salts such as, but not limited to, sodium carbonate and potassium carbonate.

Preferably, the alkali is selected from the group consisting of sodium hydroxide, potassium hydroxide, ammonium hydroxide, alkali metal salts and any combination thereof.

Even more preferably, the alkali is sodium hydroxide.

In certain embodiments, at step (i) the lignocellulosic material is treated with: (a) acid alone; (b) alkali alone; (c) sequentially with acid and then alkali; or (d) sequentially with alkali and then acid.

In a particular preferred embodiment, step (i) comprises steam impregnating the acid and/or the alkali into and/or onto the lignocellulosic material. In some embodiments, the lignocellulosic material is first pre-steamed before steam impregnating the acid and/or the alkali so that it is wetted and preheated by the steam. In this regard, pre-steaming typically causes cavities within the lignocellulosic material, such as the capillaries within wood chips, to become at least partly filled with liquid. The steam treatment may further cause air within the lignocellulosic material to expand and be, at least partly, expelled therefrom. Subsequently steam impregnating the pre-steamed lignocellulosic material may then result in the liquid within the cavities of the lignocellulosic material being replaced with the acid and/or the alkali. Alternatively, steam impregnation of the acid and/or the alkali may be performed without first pre-steaming the lignocellulosic material.

In other embodiments, the lignocellulosic material may be treated with one or more acids and/or alkalis in step (i). For example, the lignocellulosic material may be treated with 1, 2, 3, 4, 5, or more acids and/or alkalis.

For step (i), the acid may be present in an amount from about 0.1% to 5% or any range therein such as, but not limited to, about 0.3% to about 3%, or about 0.5% to about 1% by weight of the lignocellulosic material. In particular embodiments of the present invention, an acid and/or an alkali is present in step (i) in an amount of about 0.1%, 0.2%, 0.3%, 0.4%, 0.5%, 0.6%, 0.7%, 0.8%, 0.9%, 1%, 1.25%, 1.5%, 1.75%, 2%, 2.25%, 2.5%, 2.75%, 3%, 3.25%, 3.5%, 3.75%, 4%, 4.25%, 4.5%, 4.75%, 5%, or any range therein, by weight of the lignocellulosic material. In certain embodiments of the present invention, an acid and/or an alkali is present in step (i) in an amount of about 0.5% to about 2% by weight of the lignocellulosic material.

For step (i), the alkali may be present in an amount from about 0.1% to 15% or any range therein such as, but not limited to, about 0.3% to about 13%, or about 1% to about 10% by weight of the lignocellulosic material. In particular embodiments of the present invention, an acid and/or an alkali is present in step (i) in an amount of about 0.1%, 0.2%, 0.3%, 0.4%, 0.5%, 0.6%, 0.7%, 0.8%, 0.9%, 1%, 1.25%, 1.5%, 1.75%, 2%, 2.25%, 2.5%, 2.75%, 3%, 3.25%, 3.5%, 3.75%, 4%, 4.25%, 4.5%, 4.75%, 5%, 5.25%, 5.5%, 5.75%, 6%, 6.25%, 6.5%, 6.75%, 7%, 7.25%, 7.5%, 7.75%, 8%, 8.25%, 8.5%, 8.75%, 9%, 9.25%, 9.5%, 9.75%, 10%, 10.25%, 10.5%, 10.75%, 11%, 11.25%, 11.5%, 11.75%, 12%, 12.25%, 12.5%, 12.75%, 13%, 13.25%, 13.5%, 13.75%, 14%, 14.25%, 14.5%, 14.75%, 15% or any range therein, by weight of the lignocellulosic material. In certain embodiments of the present invention, an alkali is present in step (i) in an amount of about 5% to about 15% by weight of the lignocellulosic material.

In particular embodiments, step (i) further comprises washing the lignocellulosic material after treatment with the acid and/or the alkali so as to, at least partly, remove the acid and/or the alkali prior to the commencement of step (ii).

In this regard, washing may be carried out with a wash solution and/or water. The lignocellulosic material may be washed with water and/or a wash solution one or more times, such as 2, 3, 4, or more times. Preferably, if the lignocellulosic material has been treated with an acid in step (i) it is then washed with an alkaline wash solution (i.e. pH greater than 7) and/or water thereafter. Preferably, if the lignocellulosic material has been treated with an alkali in step (i) it is then washed with an acidic wash solution (i.e. pH less than 7) and/or water thereafter. Additionally, the lignocellulosic material may be washed with water one or more times after treatment with an acid or an alkali in step (i), then the lignocellulosic material is washed with a alkaline or an acidic wash solution respectively one or more times, followed by optionally washing the lignocellulosic material again with water one or more times. After one or more water and/or wash solution washes, the lignocellulosic material can be separated from the water and/or wash solution via methods such as, but not limited to, vacuum filtration, membrane filtration, sieve filtration, partial or coarse separation, or any combination thereof, prior to being treated with the agent in step (ii) of the method described herein.

The term “polyol” as used herein refers to an alcohol containing multiple hydroxyl groups. Examples of polyols of the present invention include, but are not limited to, 1,2-propanediol, 1,3-propanediol, glycerol, 2,3-butanediol, 1,3-butanediol, 2-methyl-1,3-propanediol, 1,2-pentanediol, 1,3-pentanediol, 1,4-pentanediol, 1,5-pentanedial, 2,2-dimethyl-1,3-propanediol, 2-methyl-1,4-butanediol, 2-methyl-1,3-butanediol, 1,1,1-trimethylolethane, 3-methyl-1,5-pentanediol, 1,1,1-trimethylolpropane, 1,7-heptanediol, 2-ethyl-1,6-hexanediol, 1,9-nonanediol, 1,11-undecanediol, diethylene glycol, triethylene glycol, oligoethylene glycol, 2,2′-thiodiglycol, diglycols or polyglycols prepared from 1,2-propylene oxide, propylene glycol, ethylene glycol, sorbitol, dibutylene glycol, tributylene glycol, tetrabutylene glycol, dihexylene ether glycol, trihexylene ether glycol, tetrahexylene ether glycol, 1,4-cyclohexanediol, 1,3-cyclohexanediol, or any combination thereof.

Preferably, the polyol is selected from the group consisting of glycerol, ethylene glycol and any combinations thereof.

Even more preferably, the polyol is glycerol.

The polyol can be present in pure (e.g., refined or technical grade) or impure (e.g., crude or purified crude) form. In certain embodiments of the present invention, a polyol has a purity of about 70% to about 99.9% or any range therein, such as, but not limited to, about 80% to about 99.9%, or about 80% to about 97%. In particular embodiments of the present invention, the purity of a polyol is about 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, or any range therein. Purity forms or grades (e.g., refined, crude, or purified crude) of a polyol can be, but are not limited to, purity grades produced as by-products from biodiesel production processes. In particular embodiments of the present invention, the polyol is in pure form (e.g., having a purity of 99% or more) and in other embodiments a polyol is in crude form (e.g., having a purity of from about 70% to about 98%).

In one embodiment, the glycerol is or comprises crude glycerol. Crude glycerol typically contains glycerol, methanol, inorganic salts, water, oils or fat, soap, and other “contaminants”. Crude glycerol may be produced by a variety of natural and synthetic processes. For example, crude glycerol can be produced during the process of biodiesel production. Additionally, crude glycerol may be produced during the process of saponification (e.g., making soap or candles from oils or fats). Crude glycerol produced as a byproduct of biodiesel production typically has a glycerol content of about 40-90% and can be partially refined to remove or reduce impurities such as methanol, water, salts and soaps. Partial refinement can increase the glycerol content up to about 90% glycerol, more particularly up to about 95% glycerol and in certain cases up to about 97% glycerol, approaching the purity associated with technical grade glycerol. In particular embodiments of the present invention, the glycerol content of crude glycerol is about 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97% or any range therein.

Additionally, the crude glycerol of the present invention may be subjected to one or more processes to render it more suitable and/or advantageous for use in the present invention without converting it to “pure” or technical grade/refined (e.g., >97% purity) glycerol. For example, crude glycerol for use in methods of the present invention may be subjected to a filtration step to remove solids and other large masses.

It would be appreciated by the skilled artisan that the glycerol to be used in the methods of the present invention may include a mixture of crude and refined (e.g., >97% purity) glycerol. In accordance with certain embodiments, the amount of crude glycerol may be at least 5%, more particularly at least 25%, even more particularly at least 50%, yet even more particularly at least 75% or still yet even more particularly at least 95% by weight of a total mixture of crude and technical grade glycerol by weight. In accordance with other embodiments, the glycerol comprises substantially 100% crude glycerol.

Preferably, one or more polyols may be present in the agent. For example, 1, 2, 3, 4, 5, or more polyols can be present in the agent. A polyol can be present in the agent in an amount from about 1% to about 99% by weight of the agent or any range therein, such as, but not limited to, about 1% to about 80%, about 10% to about 50%, about 15% to about 35%, about 20% to about 99%, about 40% to about 99%, or about 80% to about 97% by weight of the agent. In particular embodiments of the present invention, a polyol is present in the agent in an amount of about 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 100% or any range therein, by weight of the agent. In particularly preferred embodiments of the present invention, the polyol is present in an amount from about 80% to about 100% by weight of the agent.

For those embodiments where the agent of step (ii) comprises less than 99.9% by weight a polyol, the agent may further comprise, for example, water, an acid or an alkali. Where the agent further comprises an acid, however, the acid is to be present in an amount no more than about 0.1% by weight of the agent. As would be appreciated by the skilled artisan, this amount of acid of no more than about 0.1% by weight of the agent would not include any residual acid remaining in and/or on the lignocellulosic material following treatment with an acid in step (i) that may subsequently mix with the agent in step (ii).

For step (ii), the agent is preferably present at an amount of about 10% to about 200% or any range therein, such as, but not limited to, about 20% to about 150%, about 30% to about 100%, or about 50% to about 70% by weight of the lignocellulosic material (i.e. the agent to lignocellulosic material ratio). In particular embodiments, the agent is present at about 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 100%, 101%, 102%, 103%, 104%, 105%, 106%, 107%, 108%, 109%, 110%, 111%, 112%, 113%, 114%, 115%, 116%, 117%, 118%, 119%, 120%, 121%, 122%, 123%, 124%, 125%, 126%, 127%, 128%, 129%, 130%, 131%, 132%, 133%, 134%, 135%, 136%, 137%, 138%, 139%, 140%, 141%, 142%, 143%, 144%, 145%, 146%, 147%, 148%, 149%, 150%, 151%, 152%, 153%, 154%, 155%, 156%, 157%, 158%, 159%, 160%, 161%, 162%, 163%, 164%, 165%, 166%, 167%, 168%, 169%, 170%, 171%, 172%, 173%, 174%, 175%, 176%, 177%, 178%, 179%, 180%, 181%, 182%, 183%, 184%, 185%, 186%, 187%, 188%, 189%, 190%, 191%, 192%, 193%, 194%, 195%, 196%, 197%, 198%, 199%, 200% or any range therein, by weight of the lignocellulosic material.

Suitably, step (i) is carried out at a temperature from about 20 to 99° C., preferably about 25° C. to about 75° C. or any range therein, such as, but not limited to, about 20° C. to about 90° C. or about 25° C. to about 80° C. In particular embodiments, step (i) is carried out at a temperature of about 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., 40° C., 41° C., 42° C., 43° C., 44° C., 45° C., 46° C., 47° C., 48° C., 49° C., 50° C., 51° C., 52° C., 53° C., 54° C., 55° C., 56° C., 57° C., 58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C. and 99° C.

Suitably, step (ii) is carried out at a temperature from about 100° C. to about 220° C. or any range therein, such as, but not limited to, about 120° C. to about 200° C., about 140° C. to about 180° C., or about 150° C. to about 170° C. In particular embodiments, step (ii) is carried out at a temperature of about 100° C., 101° C., 102° C., 103° C., 104° C., 105° C., 106° C., 107° C., 108° C., 109° C., 110° C., 111° C., 112° C., 113° C., 114° C., 115° C., 116° C., 117° C., 118° C., 119° C., 120° C., 121° C., 122° C., 123° C., 124° C., 125° C., 126° C., 127° C., 128° C., 129° C., 130° C., 131° C., 132° C., 133° C., 134° C., 135° C., 136° C., 137° C., 138° C., 139° C., 140° C., 141° C., 142° C., 143° C., 144° C., 145° C., 146° C., 147° C., 148° C., 149° C., 150° C., 151° C., 152° C., 153° C., 154° C., 155° C., 156° C., 157° C., 158° C., 159° C., 160° C., 161° C., 162° C., 163° C., 164° C., 165° C., 166° C., 167° C., 168° C., 169° C., 170° C., 171° C., 172° C., 173° C., 174° C., 175° C., 176° C., 177° C., 178° C., 179° C., 180° C., 181° C., 182° C., 183° C., 184° C., 185° C., 186° C., 187° C., 188° C., 189° C., 190° C., 191° C., 192° C., 193° C., 194° C., 195° C., 196° C., 197° C., 198° C., 199° C., 200° C., 201° C., 202° C., 203° C., 204° C., 205° C., 206° C., 207° C., 208° C., 209° C., 210° C., 211° C., 212° C., 213° C., 214° C., 215° C., 216° C., 217° C., 218° C., 219° C., 220° C., or any range therein. In certain preferred embodiments, step (ii) is carried out at a temperature of about 160° C. As would be well understood by the skilled artisan, steps (i) and (ii) may be performed at different temperatures.

Step (i) is preferably performed or carried out for a period of time from about 5 minutes to about 30 minutes or any range therein, such as, but not limited to, about 5 minutes to about 25 minutes, or about 10 minutes to about 15 minutes. In certain embodiments, step (i) is carried out for a period of time of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 minutes, or any range therein. In particularly preferred embodiments, step (i) is carried out for a period of time of about 10 minutes.

Step (ii) is preferably performed or carried out for a period of time from about 5 to about 120 minutes or any range therein, such as, but not limited to, about 15 minutes to about 60 minutes, or about 20 minutes to about 40 minutes. In certain embodiments, step (ii) is carried out for a period of time of about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120 minutes, or any range therein. In particularly preferred embodiments, step (ii) is carried out for a period of time of about 30 minutes.

After treatment of the lignocellulosic material by the method described herein, the resultant modified cellulosic material may be separated from a liquid fraction by any means known to those skilled in the art. Methods of separating the modified cellulosic material from the liquid fraction may include, but are not limited to, vacuum filtration, membrane filtration, sieve filtration, partial or coarse separation, or any combination thereof. The separating step can produce a liquid fraction (i.e., filtrate or hydrolysate) and a solid residue fraction (i.e., the modified cellulosic material). In some embodiments of the present invention, water is added to the modified cellulosic material before and/or after separation. Thus, the modified cellulosic material may include the agent, residual acid, residual alkali and/or by-products from the treatment process, such as, but not limited to, polyol(s), glycerol residue, and products produced from the treatment process.

Optionally, after treatment of the lignocellulosic material with the method described herein, the modified cellulosic material may be washed with a wash solution. A wash solution may comprise an acidic solution, an alkaline solution and/or an organic solvent, but without limitation thereto.

In a further aspect, the invention provides a modified cellulosic material produced by the method hereinbefore described.

As would be readily understood by the skilled person, the methods described herein can be used to process lignocellulosic material (e.g., biomass) to a modified cellulosic material that may then be used to produce many useful organic chemicals and products. Without being bound by theory, it is believed that the modified cellulosic material described herein provides additional active sites for etherification or esterification to end-products, such as carboxymethylcellulose, methylcellulose, hydroxypropylcellulose, and the like, while simultaneously reducing the viscosity and degree of polymerization without imparting significant yellowing or discoloration, thus enabling the production of a cellulosic material that can be used for both papermaking and cellulose derivatives. Accordingly, in one embodiment, the modified cellulosic material is suitable for use in the production of a paper-based product and/or a cellulose derivative.

In one embodiment, the modified cellulosic material has a cellulose yield of about 50% to about 60% by dry weight of solid material resulting from the treatment.

In one embodiment, the modified cellulosic material is or comprises about 70% to about 90% of the content of alpha cellulose. Of the classes of cellulose, alpha cellulose has the highest degree of polymerization and is the most stable. As such, alpha cellulose is the major component of wood and paper pulp. It may be separated from other components, such as hemicelluloses, by soaking the modified cellulosic material in a solution of about 5% to about 25% (typically about 17% to about 18%) sodium hydroxide (NaOH). Accordingly, in one embodiment, hemicellulose in the modified cellulosic material is able to be substantially dissolved in about 5 to about 25% NaOH, and preferably about 18% NaOH. The remaining pure white, alpha cellulose is insoluble and can be filtered from the solution and washed prior to use in the production of paper or cellulosic polymers. A high percent of alpha cellulose in paper typically provides a stable, permanent material.

Suitably, the modified cellulosic material has a kappa number of about 50 to about 150. In particular embodiments, the kappa number is about 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150 or any range therein. In one embodiment, wherein the modified cellulosic material is derived from a lignocellulosic material treated with an alkali by the method described herein, the kappa number is about 50 to about 70. In one embodiment, wherein the modified cellulosic material is derived from a lignocellulosic material treated with an acid by the method described herein, the kappa number is about 90 to about 150.

As would be appreciated by the skilled person, the kappa number provides an estimate of the amount of chemicals required during bleaching of wood pulp to obtain a pulp with a given degree of whiteness. To this end, a higher kappa number cellulosic material typically requires higher amounts of a bleaching agent to reach a target final brightness level. As the amount of a bleaching agent needed is related to the lignin content of the pulp, the kappa number is approximately proportional to the residual lignin content of the cellulosic material. The measurement of a kappa number has been traditionally done as a laboratory analysis according to TAPPI standard method T236 which uses a back titration of residual permanganate with potassium iodide. For the present invention, the kappa number may be measured by any method known in the art.

In one embodiment, the modified cellulosic material has a solution viscosity of about 5 to about 35 mPa. As used herein, “solution viscosity” as it relates to cellulosic material, is indicative of the viscosity of a cellulose solution producible therefrom and in doing so provides an indication of the average degree of polymerization of the cellulose therein. Such a test therefore typically indicates the relative degradation (i.e., the decrease in molecular weight of the cellulose) resulting from the treatment process. By way of example, the molecular weight of cellulose therein may be estimated by determining the viscosity of cuprammonium (CuAm) solutions of the modified cellulosic material. As would be understood by the skilled artisan, however, the viscosity of the modified cellulosic material may be measured by any method known in the art.

In another aspect, the invention provides a method of producing a paper-based product including the step of treating a modified cellulosic material produced according to the method hereinbefore described to thereby produce a paper-based product.

The term “paper-based product” as used herein, includes sheet-like masses and molded products made from pulp or fibrous cellulosic material. The paper-based product is at least partly derived from the modified cellulosic material described herein. Accordingly, the paper-based product may also be partly made from an alternative source of cellulosic material, such natural or synthetic cellulosic fibers and regenerated cellulose as well as recycled waste paper.

In particular embodiments, the modified cellulosic material provides improved product characteristics in the paper-based product, such as those hereinbefore described.

In certain embodiments, the modified cellulosic material of the present invention may, with or without further modification, be used in the production of paper-based products including, but not limited to, paper, cardboard, paperboard, tissue, towel, and napkin. In one particular embodiment, the modified cellulosic material described herein is used in the production of a corrugating medium and/or a corrugated fibreboard.

Papermaking, as it is conventionally known, is a process of introducing an aqueous slurry of pulp or wood cellulosic fibres (which have been beaten or refined to achieve a level of fibre hydration and to which a variety of functional additives can be added) onto a screen or similar device (e.g., on a forming wire mesh as in the Fourdrinier process or onto a rotating cylinder) in such a manner that water is removed, thereby forming a sheet of the consolidated fibres, which upon pressing and drying can be processed into dry roll or sheet form. Typically in papermaking, the feed or inlet to a papermaking machine is an aqueous slurry or water suspension of pulp fibres which is provided from what is called the “wet end” system. In the wet end, the pulp along with other additives are mixed in an aqueous slurry and subjected to mechanical and other operations such as beating and refining. It would be appreciated that the step of treating the modified cellulosic material to produce the paper-based product may be performed by any paper making technique known in the art.

Various additives may be added to help provide or promote different properties in the paper-based product. Accordingly, in some embodiments, the step of treating the modified cellulosic material to produce the paper-based product is performed, at least part thereof, by contacting the modified cellulosic material with one or more agents selected from the group consisting of a filler agent (e.g. China clay, calcium carbonate, titanium dioxide, talc), a sizing agent (e.g. alkyl ketene dimer, alkenyl succinic anhydride, starches, rosins, gums), a bleaching agent (e.g. sodium dithionite, chlorine dioxide, hydrogen peroxide, ozone), a bleaching additive (e.g. sodium silicate), a sequestering agent (e.g. EDTA, DTPA), a wet strength additive (e.g. epichlorohydrin, melamine, urea formaldehyde, polyimines), a dry strength additive (e.g. cationic starch and polyacrylamide (PAM) derivatives), an optical brightening agent (e.g. bis(triazinylamino)stilbene derivatives) a colouring agent (e.g. a pigment or dye), a retention agent (e.g. polyethyleneimine, polyacrylamide), a coating binder (e.g. styrene butadiene latex, styrene acrylic, dextrin, oxidized starch, carboxymethyl cellulose), and any combination thereof to thereby produce the paper-based product.

In yet another aspect, the invention provides a method of producing a cellulose derivative including the step of treating a modified cellulosic material produced according to the method hereinbefore described to thereby produce the cellulose derivative.

Cellulose derivatives typically have a variety of uses including those in the food industry as a viscosity modifier or thickener, and to stabilize emulsions in various products including ice cream. Further, they may be an additive of many non-food products, such as personal lubricants, toothpaste, laxatives, diet pills, water-based paints, detergents, textile sizing, and various paper products. Specifically, cellulose derivatives have a variety of characteristics which make them useful including, for example, a high viscosity in low concentrations and their defoaming, surfactant, and bulking properties. Additionally, cellulose derivatives are typically not toxic and do not promote allergic reactions in humans.

In particular embodiments, the cellulose derivative is selected from the group consisting of a cellulose ether, a cellulose ester, viscose and microcrystalline cellulose.

In certain embodiments, the cellulose derivative is or comprises a cellulose ether. In this regard, the modified cellulosic material may have chemical properties that make it suitable for the manufacture of one or more cellulose ethers. Non-limiting examples of cellulose ethers include ethylcellulose, methylcellulose, hydroxypropyl cellulose, carboxymethyl cellulose, hydroxypropyl methylcellulose, and hydroxyethyl methyl cellulose. As would be appreciated by the skilled artisan, such cellulose ethers may be used in any application where cellulose ethers are typically used. For example, and not by way of limitation, the cellulose ethers of the disclosure may be used in coatings, inks, binders, controlled release drug tablets, and films.

Accordingly, the method of this aspect may comprise contacting (e.g., etherifying) the modified cellulosic material, optionally including the acid, the alkali, the agent and/or by-products from the method (e.g., polyol(s), glycerol residue, and products produced from the method), with one or more agents, including, but not limited to, chloromethane, chloroethane, ethylene oxide, propylene oxide, chloroacetic acid, or a combination thereof, to thereby produce the cellulose ether.

In certain embodiments, the cellulose derivative is or comprises a cellulose ester. Non-limiting examples of cellulose esters, include cellulose acetate, cellulose triacetate, cellulose propionate, cellulose acetate propionate, cellulose acetate butyrate, cellulose sulfate and cellulose nitrate. In this regard, the modified cellulosic material may have chemical properties that make it suitable for the manufacture of one or more cellulose esters. For example, and not by way of limitation, the cellulose esters of the disclosure may be used in, home furnishings, filters, inks, absorbent products, medical devices, and plastics including, for example, LCD and plasma screens and windshields.

Accordingly, the method of this aspect further comprise contacting (e.g., esterifying) the modified cellulosic material, optionally including the acid, the alkali, the agent and/or by-products from the method (e.g., polyol(s), glycerol residue, and products produced from the method), with one or more agents, including, but not limited to, acetic acid, acetic anhydride, propanoic acid, butyric acid, nitric acid, sulphuric acid or a combination thereof, to thereby produce the cellulose ester.

In one embodiment, the cellulose derivative is or comprises microcrystalline cellulose. Microcrystalline cellulose production requires relatively clean, highly purified starting cellulosic material. As such, traditionally, expensive sulfite pulps have been predominantly used for its production. Thus, the modified cellulosic material may provide a cost-effective cellulose source for microcrystalline cellulose production. The microcrystalline cellulose may be used in any application that it has traditionally been used, such as pharmaceutical or nutraceutical applications, food applications, cosmetic applications, paper applications, or as a structural composite and/or reinforcing additive. For instance, the microcrystalline cellulose may be used as a binder, diluent, disintegrant, lubricant, tableting aid, stabilizer, texturizing agent, fat replacer, bulking agent, anticaking agent, foaming agent, emulsifier, thickener, separating agent, gelling agent, carrier material, opacifier, or viscosity modifier.

Accordingly, the method of this aspect may comprise contacting (e.g., further treating or hydrolysing) the modified cellulosic material, optionally including the acid, the alkali, the agent and/or by-products from the method (e.g., polyol(s), glycerol residue, and products produced from the method), with an acid and/or alkali described herein to thereby produce microcrystalline cellulose. Preferably, the acid is hydrochloric acid. The modified cellulosic material may then be processed for the production of microcrystalline cellulose.

In one embodiment, the cellulose derivative is or comprises viscose. Typically, viscose fibre is produced by treating a cellulose material with an alkali, such as sodium hydroxide and carbon disulfide to make a solution called viscose. The viscose may be used in any application where viscose is traditionally used. For example, and not by way of limitation, the viscose may be used in cellophane, filament, food casings, tire cord and textiles, such as rayon.

Accordingly, the method of this aspect may comprise contacting the modified cellulosic material, optionally including the acid, the alkali, the agent and/or by-products from the method (e.g., polyol(s), glycerol residue, and products produced from the method), with one or more agents, including, but not limited to, sodium hydroxide, carbon disulfide, or a combination thereof, to thereby produce viscose.

As would be appreciated by the skilled person, the modified cellulosic material described herein may be used as a partial substitute for another cellulose starting material. For example, the modified cellulosic material may replace as much as 1% or more, for example 1% to 99%, of the another cellulose starting material. In this regard, the modified cellulosic material may be a cheaper alternative to the another cellulose starting material. Accordingly, a cellulose derivative or paper-based product may be derived in whole or in part from the modified cellulosic material described herein.

In particular embodiments, the modified cellulosic material may be used as a whole or partial substitute for kraft, cotton linter or sulfite pulp. As such, the modified cellulosic material may be used as a substitute for kraft, cotton linter or sulfite pulp, for example in the manufacture of cellulose ethers, cellulose acetates, viscose, and/or microcrystalline cellulose.

In another aspect, the invention provides an apparatus for producing a modified cellulosic material comprising: a treatment chamber for treating a lignocellulosic material with an acid and/or an alkali in communication with a digestion chamber for treating the lignocellulosic material with an agent that comprises, consists or consists essentially of a polyol.

Suitably, the treatment chamber is capable of impregnating the lignocellulosic material with the acid and/or the alkali. Preferably, the treatment chamber is capable of steam impregnating the lignocellulosic material with the acid and/or the alkali.

In certain embodiments, the apparatus further comprises a pre-treatment chamber which is capable of steaming the lignocellulosic material, such as for wetting and/or pre-heating the lignocellulosic material.

In some embodiments, the apparatus further comprises a separator for separating at least part thereof the modified cellulosic material from a liquid fraction.

Suitably, the apparatus is for use in the method hereinbefore described.

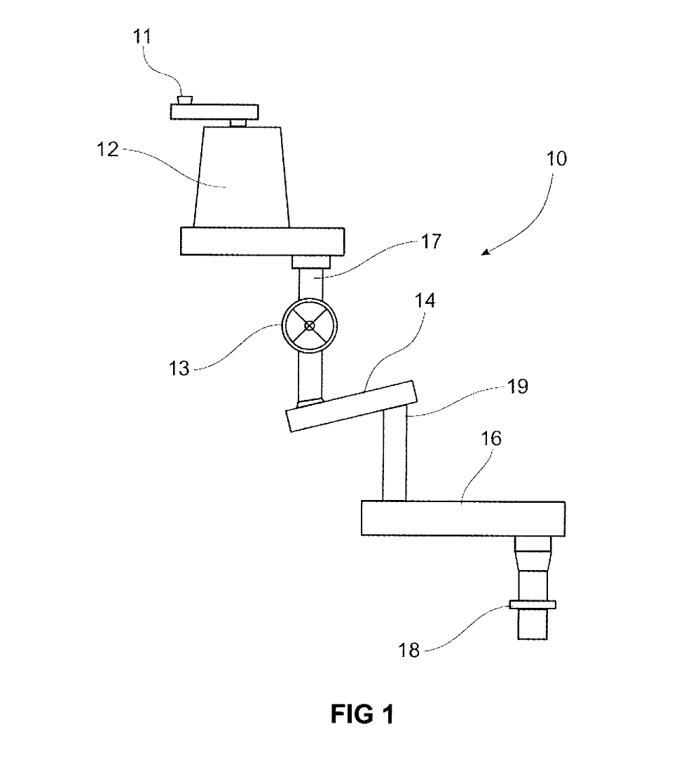

A preferred embodiment of the apparatus is shown in FIG. 1. In referring to FIG. 1, the apparatus 10 comprises an inlet 11 for receiving the lignocellulosic material to be treated or digested. From the inlet 11, the lignocellulosic material enters a pre-treatment chamber 12 which is designed to apply low pressure steam to thereby pre-wet and pre-heat the lignocellulosic material. The pre-wetted and pre-heated lignocellulosic material is then transported to the treatment chamber 14 typically by gravity feed via conduit 17, wherein it is then subsequently impregnated with an acid and/or an alkali via high pressure steam. Alternatively, lignocellulosic material may enter the apparatus 10 by way of rotary valve 13, and thereby bypasses the pre-steaming/pre-wetting process of the pre-treatment chamber 12.

The apparatus 10 further comprises a digestion chamber 16 for treating or digesting lignocellulosic material with an agent comprising a polyol, and in particular glycerol. The digestion chamber 16 is designed to digest or treat acid and/or alkali treated lignocellulosic material gravity fed from treatment chamber 14 via conduit 19 under user specified temperatures and/or pressures. Preferably, the digestion chamber 16 is adapted to digest or treat the lignocellulosic material at a low liquids to solids ratio. In this regard, the digestion chamber 16 may include a number of nozzles for spraying liquid, such as glycerol, onto the lignocellulosic material. It will also be appreciated that in alternative embodiments, conduits 17 and/or 19 may comprise or be replaced by conveyors such as belt conveyors or screw augurs that facilitate movement of lignocellulosic material as described above.

As can be seen from FIG. 1, the apparatus 10 further includes a separator 18 configured to promote separation of the digested lignocellulosic material from any remaining liquid fraction, such as by physically pressing the modified cellulosic material. Following passage through the separator 18, the digested lignocellulosic material may be at least partly separated from any agents, particularly liquid agents such as glycerol, added to the lignocellulosic material in the digestion chamber 16.

Although not demonstrated in FIG. 1, a conveyor is used to move the lignocellulosic material at a desired rate through and between the aforementioned chambers of the apparatus 10, including the pretreatment chamber 12, the steaming chamber 14; the digestion chamber 16; and the separator 18. Further, the conveyor may operate at a user-defined rate so as to achieve the required retention time in each chamber before moving the lignocellulosic material on to the next chamber.

In order that the invention may be readily understood and put into practical effect, particular preferred embodiments will now be described by way of the following non-limiting examples.

### Example 1

The objective of Example 1 was to evaluate methods of pretreating lignocellulosic material with a combination of glycerol and sulphuric acid that had been previously described (e.g., Zhang et al., Bioresource Technology, 2013).

### Materials and Methods

Sugar cane bagasse was pretreated in a continuous horizontal digester (Andritz 418 Pressurized Horizontal Digester/Conveyor). Different glycerol: “as is bagasse” ratios and digester temperatures and pressures were evaluated. Following digestion with a solution including a combination of glycerol and sulfuric acid, the bagasse was dewatered by way of a screw press (Andritz Model 560 Pressafiner) for separation of the solid and liquid phases (hydrolysate) of the pretreated bagasse.

Briefly, the raw bagasse was first weighed and then fed into the 418 Digester System under pressure. Once within the system, there were two injection nozzles to spray glycerol and sulphuric acid at an angle onto the bagasse. Upon establishment of the desired production rate, the flow of liquor was pumped at the desired flow rate to achieve the desired glycerol to “as is” bagasse ratio. The weight of sulfuric acid added to the tank was adjusted as necessary to obtain an application of approximately 1%-1.1% on O.D. bagasse. The bagasse was then moved through the digester on a conveyer belt at the desired rate to achieve the required retention time in the digester. Following digestion, the pretreated bargasse was then transferred to the 560 Pressafiner, operating at a volumetric compression ratio of 8:1. The Pressafiner was run until all its contents were dewatered and all the hydrolysate was collected. Solids and liquid fractions from each run were collected for further analysis. The pretreated solids (washed) were tested for alpha cellulose, kappa number, % ash, carbohydrate content, acid insoluble lignin content, and enzymatic saccharification. Hydrolysate samples were tested for carbohydrate content, acid soluble lignin content, % ash, and degradation products.

Six separate pretreatment conditions in the 418 Digester System were trialled on the bagasse, and these are outlined in Table 1 below. Specifically, Table 1 provides the Glycerol: “as is bagasse” ratios, sulfuric acid applications, digester retention times and operating pressures for runs A1-A6. The digester throughputs and average fiber length are also included in Tables 1 and 3 respectively.

TABLE 1
Digester Operating Conditions and Chemical Applications

| | Kg | Kg | % Sulfuric | | | |
|---|---|---|---|---|---|---|
| | Glycerol: | Glycerol: | Acid on | Retention | Digester | |
| Treatment | “as is | “as is | O.D. | Time | Pressure | Throughput |
| Group | bagasse” | bagasse” | Bagasse | (Min) | (Bar) | (ODMT/D) |
| A1 | 130 | 3.3 | 1.1 | 20 | 1.7 | 3.7 |
| A2 | 160 | 2.8 | 0.92 | 20 | 5.2 | 4.4 |
| A3 | 160 | 3.1 | 1.04 | 30 | 5.2 | 3.1 |
| A4 | 130 | 4.1 | 1.05 | 30 | 1.7 | 3.2 |
| A5 | 160 | 4.2 | 1.08 | 30 | 5.2 | 3.1 |
| A6 | 160 | 2.1 | 1.04 | 30 | 5.2 | 3.2 |

### Results

Upon performing the above trial a number of problems with the previously described pretreatment methods became apparent. In particular, a digester temperature of 130° C., as previously described in Zhang et al. supra, did not provide adequate fibre breakdown. A higher digester temperature of 160° C. provided improved fibre breakdown in this regard. Furthermore, relative low production rates were achieved with the bagasse owing largely to its low density. As such, material handling of the bagasse represents a significant hurdle to scaling up to commercial production.

TABLE 2
Kappa, Ash, Viscosity and Alpha Cellulose
on washed pretreated solids

| | | | Alpha | Alpha | Chlorited |
|---|---|---|---|---|---|
| Treatment | Kappa | Ash, | Cellulose, | Cellulose, | Viscosity, |
| Group | Number | % | % (mixer) | % (stir rod) | mPa*s |
| Untreated | — | 9.89 | — | — | — |
| Bagasse | | | | | |
| A1 | 81.0* | 5.93 | 60.7 | NM | NM |
| A2 | 106* | 7.65 | 71.1 | 74.1 | 13.7 |
| A3 | 118* | 7.36 | 74.7 | 77.8 | 13.1 |
| A4 | 81.0* | 6.27 | 62.1 | 62.3 | 16.0 |
| A5 | 112* | 7.28 | 73.5 | 77.4 | 17.0 |
| A6 | 124* | 8.94 | 77.4 | 77.9 | 12.7 |

TABLE 3
Carbohydrate composition of the washed pretreated solids fraction

| | Average | | | | | | | | | Acid | Acid | Acid |
|---|---|---|---|---|---|---|---|---|---|---|---|---|
| | Fiber | | | | | | | Total | | Soluble | Insoluble | Insoluble |
| Treatment | Length | Arabinan | Galactan | Glucan | Xylan | Mannan | Hemis | Carbs | Hemi/ | Lignin | Lignin | Residue |
| Group | (mm) | (%) | (%) | (%) | (%) | (%) | (%) | (%) | Total | (%) | (%) | (%) |
| Untreated | 1.9 | 0.6 | 41.1 | 22.1 | 0.8 | 25.3 | 66.3 | 0.38 | 1.9 | 3.8 | 18.9 | 6.4 |
| Bagasse | | | | | | | | | | | | |
| A1 | 0.48 | 1.2 | 0.4 | 43.0 | 20.1 | 0.6 | 22.4 | 65.4 | 0.34 | 3.9 | 19.8 | 4.0 |
| A2 | 0.47 | 0.8 | 0.3 | 48.5 | 15.9 | 0.6 | 17.6 | 66.2 | 0.27 | 3.4 | 19.5 | 5.8 |
| A3 | 0.50 | 0.7 | 0.3 | 50.0 | 15.1 | 0.6 | 16.8 | 66.9 | 0.25 | 3.1 | 19.5 | 5.5 |
| A4 | 0.45 | 1.0 | 0.4 | 44.8 | 20.8 | 0.6 | 22.8 | 67.6 | 0.34 | 3.4 | 19.5 | 4.5 |
| A5 | 0.52 | 0.7 | 0.3 | 49.6 | 15.1 | 0.6 | 16.7 | 66.2 | 0.25 | 3.3 | 19.0 | 6.0 |
| A6 | 0.49 | 0.6 | 0.3 | 49.3 | 11.9 | 0.6 | 13.4 | 62.7 | 0.21 | 3.6 | 20.6 | 7.2 |

TABLE 4
Carbohydrate composition of the washed pretreated liquids fraction

| | | | | | | | | | Acid |
|---|---|---|---|---|---|---|---|---|---|
| | | | | | | | Total | | Soluble |
| Treatment | Arabinose | Galactose | Glucose | Xylose | Mannose | Hemis | Carbs | Hemi/ | Lignin |
| Group | (mg/L) | (mg/L) | (mg/L) | (mg/L) | (mg/L) | (mg/L) | (mg/L) | Total | (%) |
| A1 | 412 | 147 | 576 | 1112 | ND | 1670 | 23246 | 0.74 | 0.2 |
| A2 | 786 | 217 | 973 | 4951 | 148 | 6103 | 7075 | 0.86 | 0.4 |
| A3 | 688 | 267 | 915 | 4800 | 201 | 5956 | 6871 | 0.87 | 0.4 |
| A4 | 309 | 120 | 382 | 954 | 117 | 1501 | 1883 | 0.80 | 0.3 |
| A5 | 590 | 207 | 702 | 3859 | 134 | 4790 | 5492 | 0.87 | 0.4 |
| A6 | 1110 | 367 | 1404 | 8200 | 199 | 9875 | 11279 | 0.88 | 0.5 |

### Example 2

The objective of this trial was to evaluate different glycerol and sulfuric acid treatments applied to three different substrates, bagasse, white spruce wood chips, and Eucalyptus globulus wood chips, in an attempt to improve on those pretreatment methods for lignocellulosic material previously described.

### Materials and Methods

For the trial runs involving bagasse, the bagasse was fed directly into a 418 horizontal pressurized digester using a plug screw feeder, wherein both glycerol and sulfuric acid were added at the inlet to the digester. This process was similar to that described for Example 1. Steam impregnation was not performed on the bagasse due to its bulky nature and high surface area.

For the trial runs involving spruce and eucalyptus wood chips, the wood chips were initially compressed, de-structured, and impregnated with either water or sulfuric acid in an Andritz 560 GS Impressafiner prior to being fed into a 418 horizontal pressurized digester. Glycerol with or without sulphuric acid was then added to the impregnated wood chips at the inlet to the digester. The initial chip destructing and impregnation were performed on the wood substrates in an attempt to better penetrate their fibrous structure during the pretreatment process.

Table 5 below provides the reaction parameters for each of the pretreatment trials of the bagasse, spruce and eucalyptus materials. The reaction time in the 418 digester for all runs was 30 minutes.

TABLE 5
Digester Operating Conditions and Chemical Applications

| | | | | | | Liquor | |
|---|---|---|---|---|---|---|---|
| | | | | | % Sulfuric | Flow to | |
| | | | H₂SO₄ | Glycerol: | Acid on | 418 | Digester |
| Run | | | added at | As Is | O.D. | Digester | Pressure |
| No. | Material | Impregnation | digester | Substrate | Wood | (gpm) | (bar) |
| A1 | Bagasse | No | Yes | 3.0 | 2.3 | 2.4 | 1.7 |
| A2 | Bagasse | No | Yes | 3.0 | 2.3 | 2.4 | 5.2 |
| A3 | Bagasse | No | Yes | 2.0 | 1.5 | 1.6 | 5.2 |
| A4 | Bagasse | No | Yes | 1.0 | 1.4 | 0.8 | 5.2 |
| A5 | Spruce | Yes (water) | Yes | 0.6 | 1.5 | 1.0 | 5.2 |
| A6 | Spruce | Yes (H₂SO₄) | No | 0.6 | 1.5 | 1.0 | 5.2 |
| A7 | Spruce | Yes (H₂SO₄) | No | 0.6 | 1.0 | 1.0 | 5.2 |
| A8 | Eucalyptus | Yes (H₂SO₄) | No | 1.0 | 1.0 | 1.0 | 5.2 |
| A9 | Eucalyptus | Yes (H₂SO₄) | No | 1.0 | 0.5 | 1.0 | 5.2 |
| A10 | Eucalyptus | Yes (H₂SO₄) | No | 0.5 | 0.5 | 0.5 | 5.2 |
| A11 | Eucalyptus | Yes (H₂SO₄) | No | 0.0 | 0.5 | 1.0 | 5.2 |

Digestion in the 418 Digester was performed similarly to that described for Example 1 except that Runs A6 to A11 received no further sulphuric acid therein. Following digestion, the pretreated samples from particular runs (A1-A5, A8-A11) were then transferred to the 560 Pressafiner, such that the solids and liquid fractions could collected for further analysis. The pretreated solids (washed) were tested for alpha cellulose, kappa number, % ash (Table 8), carbohydrate content, acid insoluble lignin content (Tables 9), and enzymatic saccharification (Tables 11). Hydrolysate samples were tested for carbohydrate content and acid soluble lignin content (Table 10). All pulps were further tested to standard Tappi procedures including Canadian Standard Freeness, L&W Fibre Test, bulk density and solids content.

### Results

From the above trials on the three lignocellulosic substrates, the degree of digestion or reaction was largely influenced by the percentage of sulphuric acid added. Accordingly, the amount of glycerol relative to the lignocellulosic substrate could be significantly reduced without any apparent impact on the digested material as per a visual assessment. Accordingly, pretreatment reactions were successfully performed at extremely low liquids to solids ratios, such that there is little or no free liquid within the digester. For example, the eucalyptus wood chip reacted extremely well at acid 0.7% on chip and 0.3 kg/kg Glycerol/chip which represents a liquids to solids ratio for the digestion of only 0.24:1.

For the bagasse, 130° C. at 2.4% acid still did not react the fibre fully as compared with bagasse digested at 160° C., reinforcing what was seen in Example 1. Digesting bagasse at 160° C. and 2.4% acid resulted in mud-like material that could not be pressed, indicating that the substrate was totally reacted. By decreasing the acid in the digester some fibre was retained, but the digested bagasse was more readily pressed.

Interestingly, for the spruce trial run (A6: 1.5% acid, 0.6 glycerol ratio) where the chips were impregnated with sulphuric acid by the Impressfiner, a lower freeness was observed than for the spruce trial run (A7: 1.5% acid, 0.6 glycerol ratio) where the sulphuric acid was added at the digester (Table 7). This suggests that the wood chips impregnated with acid prior to digestion and treatment with glycerol were better reacted than those not steam impregnated with acid, but digested with a solution of combined acid and glycerol. As such, the impregnation of lignocellulosic material with sulphuric acid prior to the addition of glycerol at the digestion step was superior to adding acid at the same time as glycerol to the digester.

The eucalyptus trial runs suggest that significant reductions in glycerol application are possible without affecting digestion of the lignocellulosic substrate. Eliminating glycerol altogether from the pretreatment reaction (A11: 0.5% acid), however, demonstrated the highest freeness thereby indicating a lower digestion reactivity. The eucalyptus run (A10: 0.5% acid, 0.3 glycerol ratio) performed at a similar acid concentration, but with glycerol, had a significantly lower freeness (159 mL versus 467 mL) indicating a higher reactivity.

Additionally, the eucalyptus trial runs, and in particular run A8, produced a modified cellulosic material that demonstrates product characteristics (e.g., a relatively low kappa number and a high alpha cellulose content) that may prove useful in the production of paper-based products, such cardboard and reinforcing additives, and/or cellulose derivatives, such as carboxymethyl cellulose.

TABLE 6
Material characteristics

| Lignocellulosic | % O.D. | Bulk density - wet | Bulk density - dry |
|---|---|---|---|
| Material | Solids (%) | (kg/m³) | (kg/m³) |
| Soaked spruce | 70.0 | 179.42 | 125.60 |
| Eucalyptus | 81.8 | 224.28 | 183.46 |
| Soaked Eucalyptus | 58.8 | 320.40 | 188.40 |
| Bagasse | 57.5 | 86.51 | 49.74 |

TABLE 7
Reaction Summary

| | | | | Average |
|---|---|---|---|---|
| | | | Refining | Fibre |
| | | | Energy | Length |
| Run No. | Material | Freeness (CSF) | (kWh/ODMT) | (mm) |
| A1 | Bagasse | 325 | 38 | 0.51 |
| A2 | Bagasse | 69 | 68 | 0.44 |
| A3 | Bagasse | 92 | 60 | 0.46 |
| A4 | Bagasse | 149 | 51 | 0.46 |
| A5 | Spruce | 457 | 31 | 0.45 |
| A6 | Spruce | 294 | 17 | 0.33 |
| A7 | Spruce | 195 | 18 | 0.36 |
| A8 | Eucalyptus | 132 | 12 | 0.42 |
| A9 | Eucalyptus | 189 | 11 | 0.42 |
| A10 | Eucalyptus | 159 | 18 | 0.40 |
| A11 | Eucalyptus | 467 | 17 | 0.44 |

TABLE 8
Kappa, Ash, Viscosity and Alpha Cellulose
on washed pretreated solids

| | Kappa | Kappa | | Alpha | Chlorited |
|---|---|---|---|---|---|
| Sample | Number. | Number, | Ash, | Cellulose, | Viscosity, |
| Description | As is | ground | % | % (mixer) | mPa*s |
| Eucalyptus Soak | NR | NR | 0.41 | NR | NR |
| Spruce | NR | NR | 0.12 | NR | NR |
| A1 Washed | 122.0 | 141.0 | 9.75 | 70.4 | 11.4 |
| A2 Washed | 133.8 | 108.2 | 13.7 | 77.7 | 4.35 |
| A4 Washed | 164.0 | 148.1 | 11.1 | 71.0 | 8.33 |
| A7 Washed | 117.3 | 170.1 | 0.04 | 24.0 | 3.89 |
| A8 Washed | 146.5 | 171.4 | 0.09 | 74.7 | 7.02 |
| A9 Washed | 148.1 | 163.3 | 0.07 | 72.3 | 10.8 |
| A10 Washed | 146.1 | 164.2 | 0.08 | 75.3 | 9.37 |
| A11 Washed | 109.1 | 151.4 | 0.13 | 70.4 | 14.2 |

TABLE 9
Solid Carbohydrates

| | | | | | | | | | Acid | Acid | Acid |
|---|---|---|---|---|---|---|---|---|---|---|---|
| | | | | | | | Total | | Soluble | Insoluble | Insoluble |
| Descriptive | Arabinan | Galactan | Glucan | Xylan | Mannan | Hemis | Carbs | Hemi/ | Lignin | Lignin | Residue |
| ID | (%) | (%) | (%) | (%) | (%) | (%) | (%) | Total | (%) | (%) | (%) |
| Eucalyptus | 0.3 | 1.3 | 44.1 | 14.0 | 1.0 | 16.5 | 60.7 | 0.27 | 4.4 | 22.2 | 0.0 |
| Soak | | | | | | | | | | | |
| Spruce | 1.1 | 2.3 | 43.8 | 5.3 | 12.3 | 21.0 | 64.8 | 0.32 | 0.4 | 29.5 | 0.0 |
| A1 | 0.5 | 0.2 | 46.3 | 12.3 | 0.2 | 13.2 | 59.5 | 0.22 | 1.5 | 21.6 | 7.5 |
| A2 Washed | 0.2 | <0.1 | 52.1 | 4.3 | 0.1 | 4.7 | 56.8 | 0.08 | 1.1 | 21.4 | 10.4 |
| A4 | 0.5 | <0.1 | 46.2 | 10.1 | 0.1 | 10.8 | 57.1 | 0.19 | 1.4 | 24.7 | 8.4 |
| A7 Wasted | <0.1 | 0.2 | 52.8 | 1.3 | 1.2 | 2.7 | 55.5 | 0.05 | 0.3 | 40.2 | 0.0 |
| A8 Washed | <0.1 | <0.1 | 60.6 | 2.7 | 0.4 | 3.2 | 63.7 | 0.05 | 1.9 | 29.8 | 0.0 |
| A9 Washed | <0.1 | 0.1 | 56.5 | 3.6 | 0.6 | 4.3 | 60.8 | 0.07 | 2.2 | 28.1 | 0.1 |
| A10 | <0.1 | 0.1 | 60.2 | 3.3 | 0.4 | 4.0 | 64.1 | 0.06 | 2.3 | 28.8 | 0.0 |
| A11 Washed | <0.1 | 0.2 | 55.3 | 4.8 | 0.6 | 5.7 | 61.0 | 0.09 | 2.6 | 27.5 | 0.0 |

TABLE 10
Liquid Carbohydrates

| | | | | | | | | | Acid |
|---|---|---|---|---|---|---|---|---|---|
| | | | | | | | Total | | Soluble |
| Descriptive | Arabinose | Galactose | Glucose | Xylose | Mannose | Hemis | Carbs | Hemi/ | Lignin |
| ID | (mg/L) | (mg/L) | (mg/L) | (mg/L) | (mg/L) | (mg/L) | (mg/L) | Total | (%) |
| A1 Pressate | 1665 | 633 | 4645 | 14781 | 300 | 17379 | 22023 | 0.79 | 0.4 |
| A2 Filtrate | 309 | 275 | 1663 | 7761 | 132 | 8977 | 10640 | 0.84 | 0.4 |
| 2196-2 P4 | 2427 | 4491 | 5112 | 8200 | 14170 | 29288 | 34400 | 0.85 | 0.3 |
| Pressate | | | | | | | | | |
| A5 Pressate | 200 | 330 | 489 | 8898 | 440 | 10368 | 10857 | 0.95 | 0.1 |
| A11 Pressate | 835 | 3994 | 2974 | 41863 | 2159 | 48950 | 51924 | 0.94 | 0.4 |

### Example 3

The objective of this trial was to evaluate different glycerol and sulfuric acid treatments applied to four different substrates, bagasse, poplar, Tasmanian Blue Gum and Eucalyptus globulus wood chips, in an attempt to improve on those pretreatment methods for lignocellulosic material previously described. Additionally, the objective of this trial was to evaluate crude glycerol and sodium hydroxide treatments. The crude glycerol treatments were applied to three different substrates, poplar, Tasmanian Blue Gum and Eucalyptus globulus wood chips, whilst the sodium hydroxide treatments were applied to Tasmanian Blue Gum wood chips only.

### Materials and Methods

One control run of the bagasse (A3) was performed with the bagasse fed directly to the horizontal pressurized 418 digester using a plug screw feeder. For all of the remaining trial runs on bagasse, poplar, blue gum and eucalyptus, the materials were initially compressed and destructured using a 560 Impressafiner, then impregnated with sulfuric acid prior to feeding the 418 horizontal pressurized digester. Glycerol, either pure or crude, was added to the impregnated materials at the inlet to the 418 digester.

Three trial runs of the Blue Gum wood chips (A20, A21, A22) were also conducted with sodium hydroxide (NaOH) impregnation at the Impressafiner instead of sulfuric acid. The digested alkali pre-treated pulps were subsequently refined following the 418 digester treatment using an atmospheric 401 double disc.

Table 11 below provides the material characteristics for the four furnishes. Table 12 below provides the reaction parameters for each of the pretreatment trials of the bagasse, poplar, blue gum and eucalyptus materials.

TABLE 11
Material characteristics

| | | BULK DENSITY | |
|---|---|---|---|
| | % O.D. | (kg/m³) | |
| MATERIAL | SOLIDS | WET | DRY |
| O1- Bagasse | 73.1% | 54.47 | 39.82 |
| O2- S Soaked Poplar | 80.1% | 33.64 | 26.95 |
| O3- Blue Gum | 82.0% | 249.91 | 204.92 |
| O3-S Soaked Blue Gum | 55.1% | | |
| O4- Eucalyptus | 45.6% | | |

TABLE 12
The nomenclature and pretreatment conditions used for
each of the digestion series produced during the trial

| | | | | Digester | | | % Chemical | |
|---|---|---|---|---|---|---|---|---|
| | | | | retention | Glycerol: As | | on O.D. | |
| Furnish | Impress | | Run ID | time (min) | Is Substrate | | Wood | |
| Bagasse | Yes | (I1) | A1 | (30 min) | 0.6 | (pure) | 0.70 | (acid) |
| Bagasse | Yes | (I1) | A2 | (30 min) | 1.1 | (pure) | 0.70 | (acid) |
| Bagasse | No | | A3 | (30 min) | 2.5 | (pure) | 1.67 | (acid) |
| Bagasse | Yes | (I2) | A4 | (30 min) | 0.4 | (pure) | 1.39 | (acid) |
| Bagasse | Yes | (I2) | A5 | (30 min) | 0.2 | (pure) | 1.39 | (acid) |
| Poplar | Yes | (I3) | A6 | (30 min) | 0.8 | (pure) | 1.15 | (acid) |
| Poplar | Yes | (I3) | A7 | (30 min) | 0.9 | (crude) | 1.15 | (acid) |
| Blue gum | Yes | (I4) | A8 | (30 min) | 0.8 | (crude) | 0.54 | (acid) |
| Blue gum | Yes | (I4) | A9 | (20 min) | 0.7 | (crude) | 0.54 | (acid) |
| Poplar | Yes | (I5) | A10 | (30 min) | 0.7 | (crude) | 0.62 | (acid) |
| Eucalyptus | Yes | (I6) | A11 | (30 min) | 0.8 | (pure) | 0.20 | (acid) |
| Poplar | Yes | (I7) | A12 | (30 min) | 0.9 | (crude) | 0.46 | (acid) |
| Eucalyptus | Yes | (I8) | A13 | (30 min) | 0.7 | (crude) | 0.78 | (acid) |
| Blue gum | Yes | (I9) | A14 | (30 min) | 0.7 | (crude) | 0.64 | (acid) |
| Blue gum | Yes | (I9) | A15 | (20 min) | 0.8 | (crude) | 0.64 | (acid) |
| Blue gum | Yes | (I10) | A16 | (30 min) | 0.8 | (crude) | 1.01 | (acid) |
| Blue gum | Yes | (I10) | A17 | (20 min) | 0.8 | (crude) | 1.01 | (acid) |
| Blue gum | Yes | (I11) | A18 | (30 min) | 0.9 | (pure) | 0.51 | (acid) |
| Eucalyptus | Yes | (I12) | A19 | (30 min) | 0.8 | (crude) | 0.72 | (acid) |
| Blue gum | Yes | (I13) | A20 | (30 min) | 0.6 | (crude) | 8.84 | (NaOH) |
| Blue gum | Yes | (I14) | A21 | (30 min) | 0.6 | (crude) | 13.75 | (NaOH) |

| | | | | | | | |
|---|---|---|---|---|---|---|---|
| Blue gum | Yes | (I14) | A22 | (30 min) | — | 13.75 | (NaOH) |

For each trial run, substrate was placed into drums and the tare weights were recorded. The drums were then fed to the 418 Digester System. For the bagasse, the plug screw feeder (PSF) was used as the feeding device into the 418 digester. For the wood chips, the rotary valve (RV) was use as the feeding device into the 418 digester. A feed screw at the bottom of the hopper feeds a plug screw feeder (PSF) which in turn delivers the compressed bagasse to the tee piece at the discharge end of the screw. The PSF forms a plug which acts as the pressure seal at the inlet of the digester system. The plug of material expands at the discharge bull nose end of the PSF and drops the material by gravity through the tee piece and into the inlet of the 418 horizontal digester.

Two injection nozzles at opposite ends of the tee piece spray liquid onto the biomass at an angle. The glycerol was added at the digester inlet (tee piece) before entering the horizontal digester. For the wood furnishes, the chips were discharged from the rotary valve directly into the 418 digester via the tee-piece.

A variable speed double-flighted conveyer screw in the 418 Digester moves the substrate at the desired rate to achieve the targeted retention time in the digester. Conditions available for optimization include the glycerol charge, digester retention time, dilution flow rate, and digester pressure. The digester pressure was maintained constant for all runs at 5.2 bar (75 psig). The speed of the digester screw regulates the retention time in the horizontal digester. Most of the runs were conducted at a retention time of 30 minutes, whilst some runs were also conducted at a 20 minute retention time for comparison. The digested material was then discharged into a pressurized transfer screw which, in turn, discharged into a topwinder feeder (ribbon screw) which in turn feeds an 418 Pressurized Double Disc Refiner (36″ diameter). The refiner operates at a wide gap to minimize any refining action on the digested material. The material discharged from the refiner via a blow valve after which the material was blown to an atmospheric cyclone. The material is under pressure from the plug in the PSF to the refiner blow valve.

For samples collected after the 418 digester, the solids were diluted 1:1 water to weight of sample and then drained on a vacuum table. The washed solids were then collected in bags and labelled accordingly. The washed samples were subsequently tested for alpha cellulose, kappa number, ash content, carbohydrate content (monomeric and total) and acid insoluble lignin content. Digested samples (without washing treatment) were also tested for solids determination.

### Results

### Summary

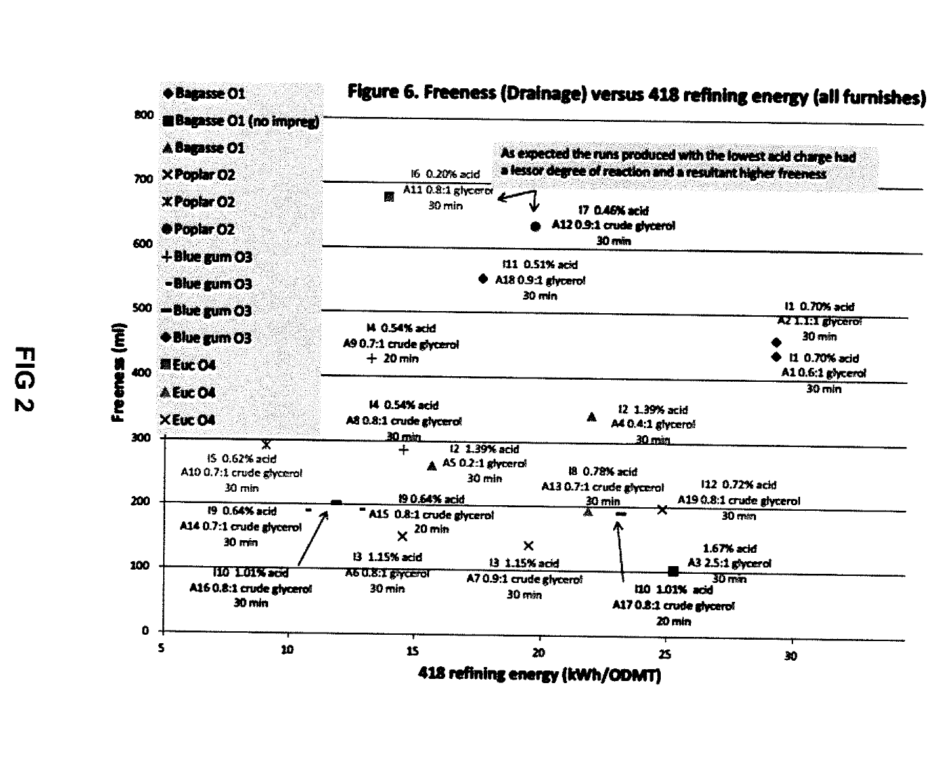

There was no observable difference using either pure or crude glycerol treatment based on visual, freeness (drainage) or LW Avg particle length assessment when compared at an equivalent sulfuric acid application (FIGS. 2, 3 and 4).

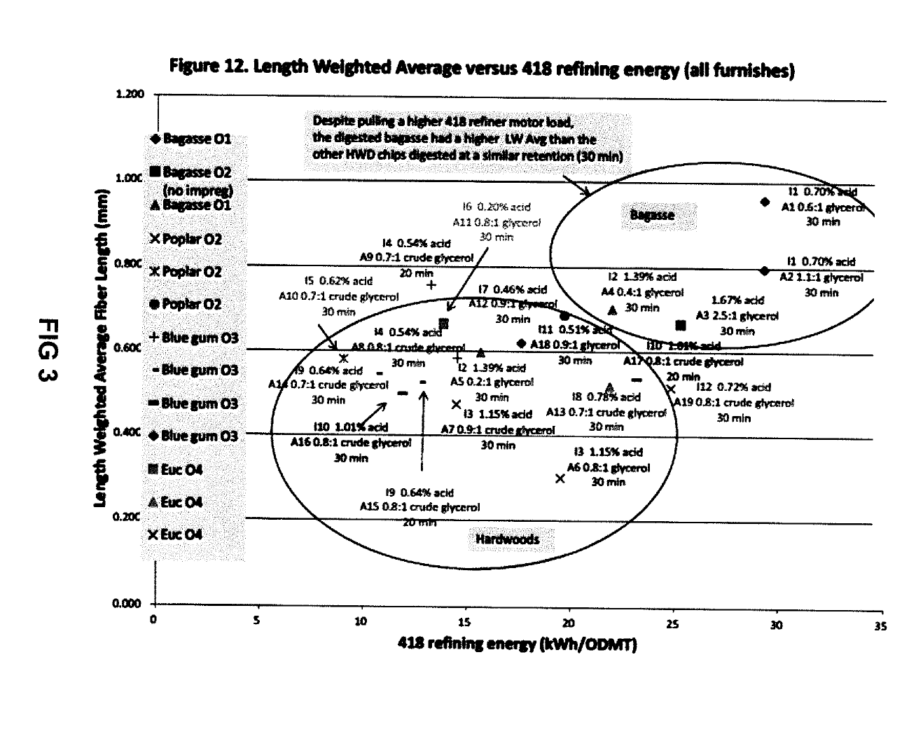

Increasing the sulfuric acid application resulted in a decrease in freeness and average fiber length with all four biomass substrates (FIG. 2). At a given application of sulfuric acid, the digested samples were relatively insensitive to changes in the glycerol application based on visual, freeness (drainage) and LW Average assessment (FIGS. 2 and 3). Values for freeness and LW Avg, however, were more sensitive to the digester retention time at lower sulfuric acid application (0.54%) and less sensitive at higher acid applications (FIGS. 2 and 3). The digested bagasse samples had a higher LW Average fiber length than the digested hard-wood furnishes (FIG. 3).

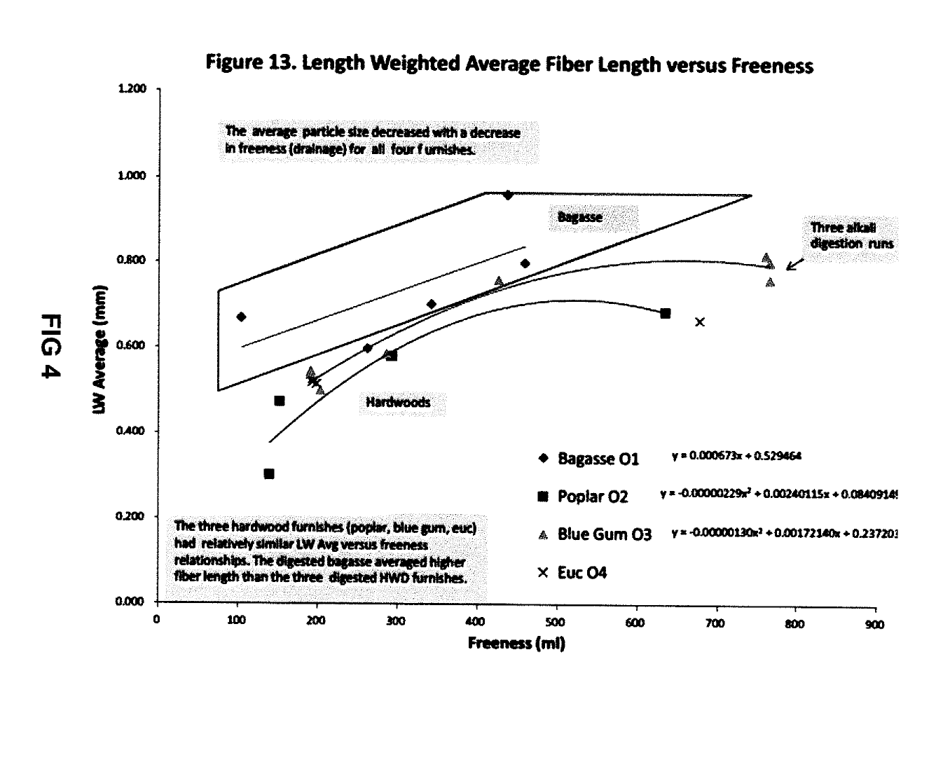

Alkali impregnation and digestion was also conducted on the blue gum furnish in this study. The alkali digested blue gum samples had a higher freeness and LW Average fiber length compared to the respective acid digested gum samples (FIG. 4). The pulps were visually less reacted and the fiber structure more intact. Subsequent refining of the alkali digested material resulted in competitive pulps for the corrugating medium market.

### A. Bagasse

At a constant acid application (0.7%) for the bagasse, decreasing the [glycerol]:[as is bagasse] application from 1.1:1 down to 0.6:1 did not result in any increase in freeness, suggesting a similar degree of reaction even at the lower glycerol application. Increasing the acid charge to 1.39% resulted in a step reduction in freeness and a reduced 418 refiner specific energy application, despite a reduction in the [glycerol]:[as is bagasse] application down to 0.2-0.4:1. Dropping the glycerol ratio from 0.4 to 0.2 did not result in an increase in freeness, suggesting the level of reaction was not compromised.

Compared at an acid application of 0.70%, the run with a higher glycerol charge (1.1:1) had a lower LW Average than the run with a glycerol charge of 0.6:1. This observation was not apparent at the higher acid application, 1.39%. Increasing the acid charge to 1.39% resulted in a reduction in LW Average despite a reduction in the [glycerol]:[as is bagasse] application down to 0.2-0.4:1.

The LW was similar for the impregnated acid point (1.39% acid, 0.4:1 glycerol) and the digester applied run (1.67%, 2.5:1 glycerol) suggesting an improved reaction efficiency with the impregnated bagasse (i.e., impregnation of the acid is a more efficient method to achieve a given degree of particle size reduction following digestion).

### B. Poplar

Further, for the poplar runs, when comparing at a similar digester retention time (30 min) and [crude glycerol]:[as is bagasse] application of 0.8-0.9, increasing the sulfuric acid application resulted in a step reduction in freeness. The run with 0.62% acid pulled a lower refiner load, which appears questionably lower than the runs produced with 0.46% and 1.15% acid.

Increasing the acid charge at a similar glycerol application resulted in a reduction in the average particle size. For the I3 impregnation with 1.15% acid, run A6 with pure glycerol had a lower LW Average than run A7 with crude glycerol. However a higher refining energy applied to run A6 most likely explains the lower LW Average particle size observed.

### C. Blue Gum

For the blue gum trials, compared at a similar acid application (0.54%) and 418 refiner energy application, the run at 30 min retention (A8) had a lower freeness than the run at 20 min retention (A9), indicating a more progressed reaction as expected. Increasing the sulfuric acid application from 0.54% to 0.64% resulted in a significant drop in freeness down to approximately 200 ml. The runs produced at 20 min retention had a relatively similar freeness (200 ml) compared to the respective samples produced at 30 min retention. However it is noted the 20 minute digested samples tended to pull a higher 418 refiner motor load when compared to the 30 min digested samples. This suggests the 20 minute samples are coarser and less reacted than the 30 minute samples. Nonetheless, a low threshold ceiling in freeness (200 ml) and LW Average (0.5 mm) was observed from the acid digested blue gum across a sulfuric acid application of 0.64% to 1.01%. This could have beneficial implications in regards to optimizing acid dosage and subsequent enzyme performance, assuming an improved enzyme response at the lower particle size of 0.5 mm. The freeness did not further decrease when the sulfuric acid charge was increased from 0.64% to 1.01%. The [crude glycerol]:[as is bagasse] applications were maintained similar at 0.7-0.8:1.

All three runs conducted with alkali pretreatment had a significantly higher freeness than the acid digested blue gum, with freeness in the range of 760-770 nil. The alkali digested blue gum was pulp like in appearance, unlike the acid digested samples that were more sludge like in appearance. The alkali digested material pulled a higher 418 refiner load due to the coarser nature of this digested material. Increasing the NaOH application from 8.84% (A20) to 13.75% (A21, A22) did not demonstrate any further reduction in pulp freeness.

The digested 8.84% and 13.75% alkali pulps were subsequently refined in an atmospheric 401 refiner to a freeness of 390 ml (A24) and 401 ml (A23) with specific energy applications of 395 kWh/ODMT and 373 kWh/ODMT, respectively. Referring to Table 13, the higher alkali pulp (A23; 13.75% NaOH) had higher refined pulp strength properties. Specifically the burst index, tear index, tensile index, stretch and TEA were higher at the higher alkali charge.

Table 13 below compares the properties of alkali digested pulp from the present trial runs to southeastern US mixed hardwood (oak, gum) alkali pulp typically used for corrugating medium production. As noted below, the pulp properties produced in these trial runs are in a similar range to that produced using alkali digestion of mixed southern hardwoods for corrugating medium production.

TABLE 13
Physical properties of alkali digested blue gum pulp samples

| | | A24 (8.8% | A23 (13.7% | Mill sample |
|---|---|---|---|---|
| | | NaOH) gum | NaOH) gum | HWD |
| Freeness | ml | 390 | 401 | 428 |
| Bulk | Cm3/g | 2.93 | 2.56 | 2.35 |
| Burst index | kPa · m2/g | 0.90 | 1.15 | 1.18 |
| Tear index | mNm2/g | 3.65 | 4.80 | 4.6 |
| Tensile index | Nm/g | 20.96 | 26.3 | 28.3 |
| TEA | J/m2 | 10.74 | 14.05 | 17.97 |
| LW Avg | mm | 0.74 | 0.74 | 0.84 |
| −200 (fines) | % | 28.3 | 26.0 | 22.3 |

For the acid-treated blue gum trial runs, the LW Avg decreased when increasing the acid application from 0.51% to 0.64%, however, further increasing the acid application to 1.01% did not demonstrate any further drop in average fiber length. This may suggest that particle size has a lower ceiling discharging from the 418 system at approximately 0.5 mm between at 0.6% to 1% acid, which provides valuable information as to the impact of fiber size on subsequent enzyme reactivity. In other words there may be no added benefit to increasing the acid concentration beyond 0.6% on enzyme performance (based on particle size), assuming the desired sugars concentrations are subsequently achieved. Similar to the observation on freeness, the runs produced at lower digester retention (20 min) tended to pull a higher 418 refiner load at a given LW Avg than the respective runs produced with 30 min retention, affirming a lesser degree of reaction.

All three runs conducted with alkali pretreatment had a significantly higher LW Avg than the acid digested blue gum, in the range of 0.8 mm. Increasing the NaOH application from 8.84% (A20) to 13.75% (A21, A22) did not demonstrate any further reduction in the average particle size. The LW Avg of the alkali digested pulp was relatively similar following 30 minutes of digestion with (A21) or without (A22) the crude glycerol treatment.

Further, values for both alpha cellulose and the viscosity of alkali pretreated Blue gum wood chips were determined, as shown in Table 14 below. The viscosity in particular was significantly higher for alkali pretreated material than that of acid pretreated material. Accordingly, this material may pose a better candidate for cellulose derivatives than acid pretreated materials.

TABLE 14
Kappa, Ash, Viscosity and Alpha Cellulose
on washed pretreated solids

| | | Kappa | | Alpha | Chlorited |
|---|---|---|---|---|---|
| Sample | | Number. | Ash, | Cellulose, % | Viscosity, |
| Description | ID # | As is | % | (mixer) | mPa*s |
| Trial 2196-3 | S2014- | 120.0 | 1.14 | 78.2 | 22.1 |
| A20 DI | 2983 | | | | |
| washed Solid | | | | | |
| Trial 2196-3 | S2014- | 120.2 | 1.23 | 81.3 | 34.9 |
| A21 DI | 2984 | | | | |
| washed Solid | | | | | |

D. Eucalyptus globulus

An initial run on the eucalyptus chips was produced at a low sulfuric acid charge (0.20%) resulting in a high freeness with a coarser appearance, indicative of a milder reaction at a low acid charge. Increasing the acid charge to 0.72%-0.78% resulted in a significant drop in freeness and a more progressed reaction. The [glycerol]:[as is bagasse] applications were similar for all the eucalyptus digester runs at 0.7-0.8:1. The two runs produced at a similar acid application (0.72%-0.78%) and digester retention time (30 min) had similar freeness, 193 ml and 198 ml, demonstrating a similar replication at similar conditions.

The initial run on the eucalyptus chips produced at a low sulfuric acid concentration (0.20%) had the highest LW Avg fiber length, 0.67 mm. Increasing the acid concentration to 0.72%-0.78% resulted in a drop in LW Avg down to 0.52 mm. The [glycerol]:[as is bagasse] applications were similar for all the eucalyptus digester runs at 0.7-0.8:1. The two runs produced at a similar acid application (0.72%-0.78%) and digester retention time (30 min) had an equivalent LW Avg. again demonstrating a similar replication at similar conditions.

1. A method for producing a modified cellulosic material comprising the steps:
(i) treating a lignocellulosic material with an acid and/or an alkali;
(ii) treating the lignocellulosic material of step (i) with an agent that comprises, consists or consists essentially of a polyol;
thereby producing a modified cellulosic material.

2. The method of claim 1, wherein at step (i) the lignocellulosic material is treated with: (a) acid alone; (b) alkali alone; (c) sequentially with acid and then alkali; or (d) sequentially with alkali and then acid.

3. The method of claim 1, wherein the acid is selected from the group consisting of sulphuric acid, hydrochloric acid, phosphoric acid, hydrofluoric acid, hydrobromic acid, nitric acid, acid metal salts and any combination thereof.

4. The method of claim 3, wherein the acid is sulphuric acid.

5. The method of claim 1, wherein the alkali is selected from the group consisting of sodium hydroxide, potassium hydroxide, ammonium hydroxide, alkali metal salts and any combination thereof.

6. The method of claim 5, wherein the alkali is sodium hydroxide.

7. The method of claim 1, wherein step (i) comprises steam impregnating the acid and/or alkali into and/or onto the lignocellulosic material.

8. The method of claim 1, wherein (i) the acid is present in an amount of about 0.1% to about 5% by weight of the lignocellulosic material; and/or (ii) the alkali is present in an amount of about 0.1% to about 15% by weight of the lignocellulosic material.

9. The method of claim 1, wherein the polyol is selected from the group consisting of glycerol, ethylene glycol and any combination thereof.

10. The method of claim 9, wherein the polyol is glycerol.

11. The method of claim 1, wherein step (i) is carried out at a temperature from about 20° C. to about 90° C.

12. The method of claim 1, wherein step (ii) is carried out at a temperature from about 120° C. to about 200° C.

13. The method of claim 12, wherein step (ii) is carried out at a temperature of about 160° C.

14. The method of claim 1, wherein step (i) is carried out for a period of time from about 5 minutes to about 30 minutes.

15. The method of claim 1, wherein step (ii) is carried out for a period of time from about 15 minutes to about 60 minutes.

16. The method of claim 15, wherein step (ii) is carried out for a period of time of about 30 minutes.

17. The method of claim 1, wherein step (i) further comprises washing the lignocellulosic material after treatment with the acid and/or alkali so as to, at least partly, remove the acid and/or alkali prior to the commencement of step (ii).

18. The method of claim 1, wherein the polyol is present at an amount of about 10% to about 200% by weight of the lignocellulosic material.

19. A method of producing a paper-based product including the step of treating the modified cellulosic material produced according to claim 1 to produce a paper-based product.

20. The method of claim 19, wherein the step of treating the modified cellulosic material is performed, at least part thereof, by contacting the modified cellulosic material with one or more agents selected from the group consisting of a filler agent, a sizing agent, a bleaching agent, a bleaching additive, a sequestering agent, a wet strength additive, a dry strength additive, an optical brightening agent, a colouring agent, a retention agent, a coating binder and any combination thereof.

21. A method of producing a cellulose derivative including the step of treating a modified cellulosic material produced according to claim 1 to produce the cellulose derivative.

22. The method of claim 21, wherein the cellulose derivative is selected from the group consisting of a cellulose ether, a cellulose ester, viscose and microcrystalline cellulose.

23. The method of claim 22, wherein the cellulose ether is selected from the group consisting of ethylcellulose, methylcellulose, hydroxypropyl cellulose, carboxymethyl cellulose, hydroxypropyl methylcellulose, hydroxyethyl methylcellulose and any combination thereof.

24. The method of claim 23, wherein the step of treating the modified cellulosic material includes contacting the modified cellulosic material with one or more agents selected from the group consisting of chloromethane, chloroethane, ethylene oxide, propylene oxide, chloroacetic acid and any combination thereof to thereby produce the cellulose ether.

25. The method of claim 22, wherein the cellulose ester is selected from the group consisting of cellulose acetate, cellulose triacetate, cellulose propionate, cellulose acetate propionate, cellulose acetate butyrate, cellulose sulphate, cellulose nitrate and any combination thereof.

26. The method of claim 25, wherein the step of treating the modified cellulosic material includes contacting the modified cellulosic material with one or more agents selected from the group consisting of acetic acid, acetic anhydride, propanoic acid, butyric acid, nitric acid, sulphuric acid and any combination thereof to thereby produce the cellulose ester.

27. The method of claim 22, wherein the step of treating the modified cellulosic material includes contacting the modified cellulosic material with an acid and/or alkali to thereby produce microcrystalline cellulose.

28. The method of claim 22, wherein the step of treating the modified cellulosic material includes contacting the modified cellulosic material with one or more agents selected from the group consisting of sodium hydroxide, carbon disulphide and any combination thereof to thereby produce viscose.

29. A modified cellulosic material produced by the method according to claim 1.

30. A paper-based product produced by the method according to claim 19.

31. A cellulose derivative produced by the method according to claim 21.

32. An apparatus for producing a modified cellulosic material comprising: a treatment chamber for treating a lignocellulosic material with an acid and/or an alkali in communication with a digestion chamber for treating the lignocellulosic material with an agent that comprises, consists or consists essentially of a polyol.

33. The apparatus of claim 32, wherein the treatment chamber is capable of impregnating the lignocellulosic material with the acid and/or the alkali.

34. The apparatus of claim 32, further comprising a pre-treatment chamber which is capable of steaming the lignocellulosic material, such as for wetting and/or pre-heating the lignocellulosic material.

35. The apparatus of claim 32, further comprising a separator for separating at least part thereof the modified cellulosic material from a liquid fraction.

36. (canceled)
